(19) United States
(12) Patent Application Publication
(10) Pub. No.: US 2012/0128334 A1
(43) Pub. Date: May 24, 2012

(54) APPARATUS AND METHOD FOR MASHUP OF MULTIMEDIA CONTENT

(75) Inventors: Lai-Tee CHEOK, Dallas, TX (US); Nhut NGUYEN, Richardson, TX (US); Jaeyeon SONG, Seoul (KR); Sungryeul RHYU, Yongin-City (KR); Seo-young HWANG, Suwon-si (KR); Kyungmo PARK, Seoul (KR)

(73) Assignee: SAMSUNG ELECTRONICS CO. LTD., Suwon-si (KR)

(21) Appl. No.: 13/296,900

(22) Filed: Nov. 15, 2011

Related U.S. Application Data
(60) Provisional application No. 61/415,708, filed on Nov. 19, 2010.
(60) Provisional application No. 61/416,123, filed on Nov. 22, 2010.

(51) Int. Cl. H04N 5/93

(52) U.S. Cl. 386/278; 386/E05.028

(57) ABSTRACT

An apparatus and method for combining multimedia data are provided. The method includes obtaining first multimedia content from a first source, obtaining second multimedia content from a second source, selectively combining the first multimedia content with the second multimedia content, and outputting the selectively combined multimedia content. According to implementations of the invention, selected portions and/or fragments of multimedia content may be mashed up rather than the entirety of the multimedia content from either or both sources. Also, the mashup of the multimedia content may be varied and adapted based on the characteristics of the device performing the mashup as well as the characteristics of the available transport mechanism. Finally, implementations of the invention provide for flexible transformation and precise synchronization among multimedia elements.

### CROSS-REFERENCE TO RELATED APPLICATIONS

This application claims the benefit under 35 U.S.C. §119(e) of a U.S. Provisional application filed on Nov. 19, 2010 in the U.S. Patent and Trademark Office and assigned Ser. No. 61/415,708, and of a U.S. Provisional application filed on Nov. 22, 2010 in the U.S. Patent and Trademark Office and assigned Ser. No. 61/416,123, the entire disclosure of each of which is hereby incorporated by reference.

### BACKGROUND OF THE INVENTION

1. Field of the Invention

The present invention relates to an apparatus and method for providing a mashup function. More particularly, the present invention relates to an apparatus and method for providing a language and a file format for mashup of multimedia content.

2. Description of the Related Art

The term “mashup” refers to the integration of content, obtained from disparate sources, to create new data that supports a new functionality. By the integration or hybridization of information, which includes the reuse and mixing of available content through associations and recombination, new and enhanced services can be provided to users. For example, an enterprise mashup may integrate real-time commodities performance data with an analytical tool to allow a security trader to track a large number of portfolios. As another example, a consumer mashup may combine user location information with a search tool that locates other users or desired locations within a certain radius of the user, or may combine user location information with weather information, train schedules, information from a Social Networking Site (SNS), and the like.

FIGS. 1A and 1B illustrate examples of mashups according to the related art.

Referring to FIG. 1A, a first example is provided in which a user's location information is combined with geographic information within a given radius of the user's location. Here, the user's location information may be Global Positioning System (GPS) information and the geographic information may include historical sites of interest, restaurants, and the like. As a result of the combination or mashup of the information, a map is displayed that illustrates several items of geographic information 101 located within a selected radius of the user. Moreover, upon choosing a selected item of geographic information 103, the selected information may be enlarged and displayed with additional information 105. Thus, the user is able to select a desired destination and determine a best route to the desired location.

Referring to FIG. 1B, a second example is provided in which a user's location information is combined with information concerning the location of other users. As a result of the mashup of these two pieces of information, a map is presented on which the user's location 107 is displayed, as is the other users' respective locations 109. In that case, the user is able to determine which users are nearby, a distance to each user, and the like. This example illustrates mashup of several information sources and services including current user location (which can be obtained via GPS information), map service, as well as information of other users (e.g., friends of the current user) pulled from an SNS such as Twitter, Facebook, and the like.

The mashup of information described above can be achieved using programming code as defined in the Enterprise Mashup Markup Language (EMML) specification, provided by the Open Mashup Alliance (OMA), and as defined by the Hypertext Markup Language (HTML) 5 specification, provided by the World Wide Web Consortium (W3C). The OMA is a non-profit consortium whose goal is to facilitate the successful adoption of mashup technologies as well as to standardize the EMML specification so as to increase interoperability and portability of mashup solutions. Key features of the EMML specification include the ability to integrate data from multiple sources, support database queries (e.g., search for a customer name with a particular customer identification, search for movies with specific titles, etc.), invoke services (e.g. Facebook, Twitter, Really Simple Syndication (RSS) feeds, etc.), and support operations for transforming and formulating data (e.g., filter, sort, join/merge, etc.). Table 1 provides a list of EMML operations/functions.

TABLE 1

| Operations/ | EMML | |
|---|---|---|
| Functions | Elements | Description |
| Variables and | <variables>, | Variables to hold input |
| parameters | <input>, <output> | parameters and results of |
| | | mashup |
| Data source | <datasource> | Defines connection to |
| | | database for use with |
| | | Structured Query Language |
| | | (SQL) statements in mashup |
| Issue SQL | <sql> | Execute SQL queries to |
| statements | | datasource |
| Invoke component | <directinvoke> | Invokes web services or |
| services | | web site at a publicly |
| | | accessible Uniform |
| | | Resource Locator (URL); |
| | | HTML, RSS, supported |
| Combine component | <join>, <merge> | Joins results based on a join |
| service results | | condition or simply merges |
| | | results that have identical |
| | | structures |
| Mashup processing | <if>, <for>, | Syntax to control flow of |
| flow | <foreach>, | mashup program/process |
| | <while>, <break>, | |
| | etc. | |
| Transforming | <filter>, <group>, | Transforms results by |
| intermediate | <sort>, <script>, | grouping, filtering, sorting, |
| results | <xslt>, etc. | etc. |

As can be seen in Table 1, the EMML specification supports database queries and provides a mechanism for acquiring and integrating data from multiple locations and for transforming and formulating the acquired results. However, while it is useful for data analysis, it is not designed to handle multimedia content such as video, audio, and the like.

The HTML5 specification supports a geo-location Application Programming Interface (API) and allows geographical location information to be queried and combined with other data from disparate sources to create a new location-aware mashup service. As in the above illustrated examples, HTML5 can be used to combine location information with a search made on an SNS to search for other users within a certain radius of a user's current location.

HTML 5 also provides for embedding of video information. However, it is limited in this capability because it lacks support for allowing precise synchronization and interactivity among multimedia components. Furthermore, there is not an existing mashup mechanism that provides a method to specify mashup behavior according to a transport system environment or terminal characteristics.

Therefore, there is a need for an advanced and flexible method to specify mashups for multimedia content and to support synchronization and interactivity among multimedia components so as to provide sophisticated multimedia services to users.

There is also a need for a file format for storing and distributing multimedia mashup content. In this case, the term “file format” refers to a mechanism for encoding information for storage in a file. For example, certain file formats are designed to store a particular type of data (e.g., .PNG for storing bitmapped images, .WAV for storing audio data, etc.). However, there is not currently a file format for storing and distributing multimedia mashup content.

The International Organization for Standardization/International Electrotechnical Commission (ISO/IEC) has standardized the ISO Base Media File Format (ISOBMFF), which is a file format designed to contain timed multimedia information (video, audio, etc.) for presentation in a flexible, extensible format to facilitate interchange, and easy management of media content. In this regard, the Moving Picture Experts Group (MPEG)-4 Part 14 File Format (MP4 FF), which is derived from the ISOBMFF, is provided for storing different media types in an MPEG-4 presentation. The MPEG-4 presentation can be composed of video and audio streams multiplexed together as well as metadata (such as subtitles), images, synthetic objects, and the like. However, even though the MP4 file format is capable of storing multimedia content and objects, as well as the relationships and interactivity among these objects, it does not provide support for connecting to databases for retrieving external content and does not store descriptions of how the multimedia content could be mashed up/combined.

The MPEG-21 FF is another standardized file format derived from the ISOBMFF. The MPEG-21 standard provides an open framework for delivery and consumption of multimedia content and ensures interoperability among users to exchange, access, and consume digital items. A digital item can refer to, for instance, a music album, a video collection, a web page, etc. The MPEG-21 FF provides a standardized method of storing descriptions of content in a file as well as a method to reference external data from multiple sources, which is a desirable property of mashup content. However, the MPEG-21 FF does not provide a flexible method of specifying the use of mashup data (i.e., specify behavior of mashups), nor does it allow precise description of temporal and spatial composition of multimedia content, which is critical for mashup of multimedia content.

Thus, there is also a need for a file format that provides for storage of mashup related information and for specifying mashup behavior of the content.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for mashup of multimedia content.

Another aspect of the present invention is to provide an apparatus and method for mashup of multimedia content that allows content to be accessed and queried from multiple sources, databases, and the like.

Yet another aspect of the present invention is to provide an apparatus and method for mashup of multimedia content that supports multiple services, applications, and the like.

Still another aspect of the present invention is to provide an apparatus and method for mashup of multimedia content that enables spatial and temporal composition of multimedia content components.

Another aspect of the present invention is to provide an apparatus and method for mashup of multimedia content that allows precise synchronization among multimedia elements.

Yet another aspect of the present invention is to provide an apparatus and method for mashup of multimedia content that provides flexibility when specifying how content should be mashed up (i.e., flexibility in controlling mashup behavior).

Still another aspect of the present invention is to provide an apparatus and method for mashup of multimedia content that provides for re-mix of available content to produce new content, thus alleviating the need to re-create content.

Another aspect of the present invention is to provide an apparatus and method for mashup of multimedia content that allows easy creation of customized content.

Yet another aspect of the present invention is to provide an apparatus and method for mashup of multimedia content that enables recombination of portions/fragments of an entire content (i.e., fine-granularity mashups).

Still another aspect of the present invention is to provide an apparatus and method for mashup of multimedia content that provides flexible operations of content (e.g., filter, merge, sort, etc.) to easily transform and formulate mashup results for presentation to a user.

Another aspect of the present invention is to provide an apparatus and method for mashup of multimedia content that can specify mashup behavior according to a terminal profile.

Yet another aspect of the present invention is to provide an apparatus and method for mashup of multimedia content by which service providers can adaptively specify mashup behaviors according to transport system profiles.

In accordance with an aspect of the present invention, a method for combining multimedia data is provided. The method includes obtaining first multimedia content from a first source, obtaining second multimedia content from a second source, selectively combining the first multimedia content with the second multimedia content, and outputting the selectively combined multimedia content.

In accordance with another aspect of the present invention, an apparatus for combining multimedia data is provided. The apparatus includes a transceiver unit for obtaining first multimedia content from a first source and for obtaining second multimedia content from a second source, and a control unit for selectively combining the first multimedia content with the second multimedia content and for controlling output the selectively combined multimedia content by the transceiver.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B illustrate examples of mashups according to the related art;

FIG. 2 illustrates a timing diagram of multimedia content after mashup according to an exemplary embodiment of the present invention;

FIG. 3 illustrates a mashup of selected portions of multimedia content according to an exemplary embodiment of the present invention;

FIG. 4 illustrates a software script including a Multimedia Mashup Markup Language (M3L) fragment according to an exemplary embodiment of the present invention;

FIG. 5 is a diagram illustrating a file format for storing multimedia mashup content according to an exemplary embodiment of the present invention;

FIG. 6 illustrates a syntax for use in a mashup file format according to an exemplary embodiment of the present invention; and

FIG. 7 is a block diagram of an apparatus for executing an M3L script according to an exemplary embodiment of the present invention.

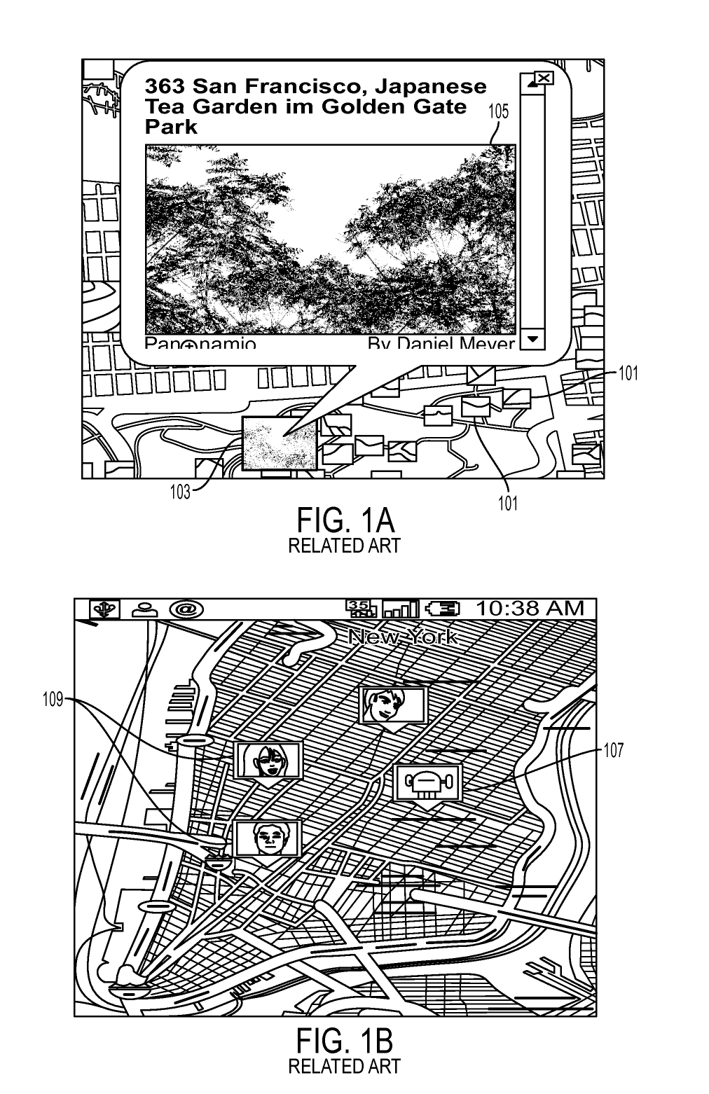

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The term “mashup” refers to a technology that allows easy creation of new data and services by combining or mashing-up existing data and services. Exemplary embodiments of the present invention provide a mechanism to effectively create and deliver mashup of not just data, but of multimedia content in a flexible and cost-effective way. That is, exemplary embodiments allow for the re-use of already available content or services that involve more sophisticated/interactive media content, thus user experience is enhanced at a reduced cost. Also, exemplary embodiments of the present invention provide a mechanism to efficiently store and deliver multimedia mashup content as well as meta-information used for specifying how content could be mashed up (i.e., mashup behavior).

In more detail, exemplary embodiments of the present invention include an apparatus and method for seamless integration/mashup of multimedia content from multiple sources. To support this novel feature, exemplary embodiments of the present invention provide a new markup language, designated as Multimedia Mashup Markup Language (M3L), which allows multimedia content to be accessed and processed from multiple sources, and to be easily combined and formulated for presentation to a user. Moreover, exemplary embodiments of the present invention allow a user to specify how the multimedia content could be mashed up in a flexible manner (i.e., allow a user to more flexibly specify the behavior of a mashup). Furthermore, exemplary embodiments of the present invention allow for precise timing control among the multimedia elements to provide interactive multimedia mashup content and services. The description below first provides exemplary embodiments of the present invention and next provides a description and example of M3L.

In addition to the flexible hybridization of multimedia content from any source, an exemplary embodiment of the present invention provides a mechanism to allow spatial and temporal composition of multimedia elements. The exemplary mechanism disclosed in the present invention provides the mashup content and service authors with, among other things, the ability to precisely prescribe the synchronization and interactivity among multimedia components to create innovative and sophisticated multimedia services for the users.

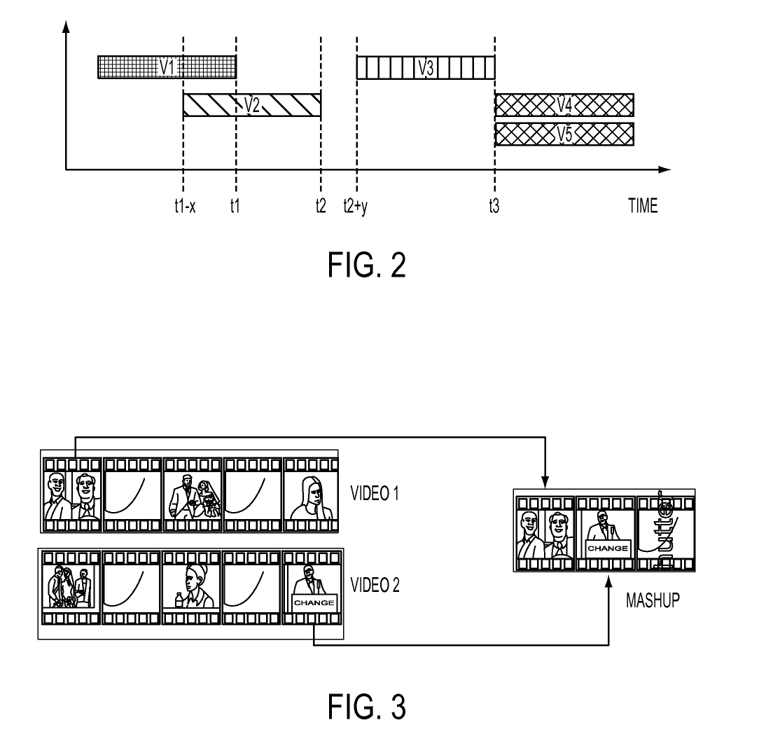

FIG. 2 illustrates a timing diagram of multimedia content after mashup according to an exemplary embodiment of the present invention.

Referring to FIG. 2, a mashup of first multimedia content V1, second multimedia content V2, third multimedia content V3, fourth multimedia content V4, and fifth multimedia content V5 is illustrated. Each of the multimedia content V1˜V5 may include any type of data including audio data, video data, and the like. Moreover, each of the multimedia content V1˜V5 may be respectively selected and/or obtained from five distinct sources.

As illustrated in FIG. 2, the timing of the multimedia content can be precisely controlled and synchronized and the temporal relationship among the multimedia content can be defined in a very flexible manner. For example, playback of multimedia content V2 may begin x seconds before playback of multimedia content V1 ends. Similarly, playback of multimedia content V3 may begin y seconds after playback of multimedia content V2 ends. As another example, multimedia content V4 and V5 can be designated to playback concurrently at a time t3, which is the time that playback of multimedia content V3 ends. Such concurrent playback may be advantageous in a situation where there is a plurality of cameras capturing an event from different angles, such as a sporting event, so that different views of the same event can be displayed concurrently on a user's television or other display apparatus.

Of course, although FIG. 2 illustrates the mashup of five different multimedia contents, it is to be understood that this is merely for sake of convenience of description. It is not intended to be limiting and should not be construed as such. Rather, it is understood that exemplary implementations of the present invention may include any number of multimedia contents and any combination of temporal arrangements. That is, exemplary embodiments of the present invention provide great flexibility in controlling the arrangement of the mashup content.

FIG. 3 illustrates a mashup of selected portions of multimedia content according to an exemplary embodiment of the present invention.

Referring to FIG. 3, video 1 and video 2 represent multimedia content available from two distinct sources. In the illustrated example, video 1 may represent multimedia content of a news broadcast from a first service provider while video 2 may represent multimedia content of a news broadcast from a second service provider. Video 1 contains several segments covering different topics (e.g., a presidential debate, followed by a popular wedding, and a notorious trial), while video 2 may cover the same or different programs in a different order.

As illustrated in FIG. 3, a user that desires to view only a specific news topic, such as the presidential debate, is able to designate such a request in a mashup of the multimedia content. That is, the user may designate a mashup of the video 1 multimedia content and the video 2 multimedia content such that only desired segments (e.g., those of the presidential debate) from video 1 and video 2 are provided. In the illustrated example, the topic specific mashup would be achieved by mixing only the first segment of video 1 and the last segment of video 2 to produce a new content as shown in the resultant mashup in FIG. 3. The new content can be created in real-time from available content without having to perform manual editing.

Of course, the example provided in FIG. 3 is merely for sake of description and in no way limiting in the application of the invention. For example, the entirety of a news clip concerning the presidential debate need not be included in a resultant mashup. Rather, in an exemplary implementation, portions and/or fragments of multimedia content may be selected, rather than the entire multimedia content. A mashup using such a fragmented selection is referred to as a “fine granularity mashup.” For instance, the first 4 minutes of a 10-minute video clip can be mashed with the last 2 minutes of another video clip.

Another exemplary embodiment of the present invention provides a mechanism for a mashup service provider or content creator to specify a different mashup behavior depending on the characteristics of a transport system. For example, the mashup provider may consider whether the transport system uses a hybrid delivery, uses a streaming system, uses a broadcast system, etc. This allows the mashup service provider to take advantage of different characteristics associated with each transport profile. For instance, if the mashup content is being delivered using a hybrid delivery that includes two delivery channels, such as a broadcast channel and a broadband channel that provides additional bandwidth and interactivity, a content creator can use the present invention to specify mashup behavior and content that can leverage the extra bandwidth and interactivity provided by hybrid delivery but, when the transport system is broadcast only, the mashup behavior can be limited to that supported by the smaller bandwidth and without interactivity.

In yet another exemplary embodiment, the present invention allows the service providers and content creators to specify mashup behavior according to the profile of a terminal on which the mashup will be received. For example, mashup content consumption on a smartphone can be specified differently than when the same content is consumed on a high definition television, which has a larger display screen. The mashup behavior specified for the latter can take advantage of the larger screen size to create a different mashup content consumption experience.

Table 2 provides a list of elements and attributes and detailed M3L syntax. These elements and attributes allow users to specify multiple content sources, as well as fragments of a source (i.e., less than the entire content). Multiple services can be invoked to derive relevant results that can be merged and presented to the users in a flexible manner. Users can specify how the sources should be mashed up (mashup behavior) to create new content/services as well as precise spatial and temporal layout of the mashed up multimedia elements.

TABLE 2

| Elements | Attributes | Description |
|---|---|---|
| m31 | | Root element of mashup; |
| | | children elements are |
| | | <content> and <query> |
| content | | Element to declare content sources; |
| | | allows declaring either the entire |
| | | content source, or portions to be |
| | | mashed up |
| | id | Identifier |
| | url | Link/reference to content sources |
| | offset | Offset from beginning of video |
| | | (value can be in secs, mins, etc.) |
| | duration | Duration of the video (value can be |
| | | in secs, min, or a fraction of the |
| | | entire video length) |
| | to | Ending of video segment |
| | | (in secs, min, etc.) |
| service | | Specifies one or more services |
| invoke | | Invoke/launch services |
| | url | Identifies location/pointer to |
| | | services to be invoked |
| | result | Stores result of invoked services |
| query | | Element to perform search and query |
| | | operations from a single or multiple |
| | | disparate content sources; children |
| | | elements are <sql> |
| | src | Reference/link to database server |
| | username | Username credentials for user to log in |
| | password | Password credentials |
| | db_name | Database table name |
| sql | | Element to specify SQL statement |
| | string | Database query command |

In Table 2, the element <m31> represents the root element of an exemplary mashup script. In implementation, there should be one such element at the beginning of each script. This element has several child elements, including <content>, <service>, <invoke>, <query>, and <sql>.

The <content> element is used to declare various content sources. In an exemplary implementation, it includes attributes for referencing either the entire content or fragments/portions of the entire content to be mashed up. More specifically, the <content> element includes attributes of “id”, “url”, “offset”, “duration”, and “to”. The attributes “id” and “url” (i.e., identifier and uniform resource link) are used to uniquely identify the content sources and reference their locations. The attributes “offset”, “duration”, and “to” are timing attributes to allow flexible mashup of different segments of the content from different sources or multiple, disjointed segments from the same source.

The <service> element is used to specify one or more services and the <invoke> element is used to invoke or launch a specified service. The <invoke> element includes attributes of “url” and “result”. The “url” attribute is used to identify a location or a pointer of a service to be invoked, and the “result” attribute is used to facilitate the storing of a result of an invoked service.

The <query> element is used to execute a database query by specifying a database source and credentials. The <query> element includes attributes of “src”, “username”, “password”, and “db name”. The “src” attribute is used to designate a location/path to the database server, and the “db name” attribute is provided for designating a specific database. The “username” and “password” attributes are provided for supplying credentials used for identification and security purposes.

The <sql> element is provided to initiate a query command and includes a “string” attribute for containing the search command.

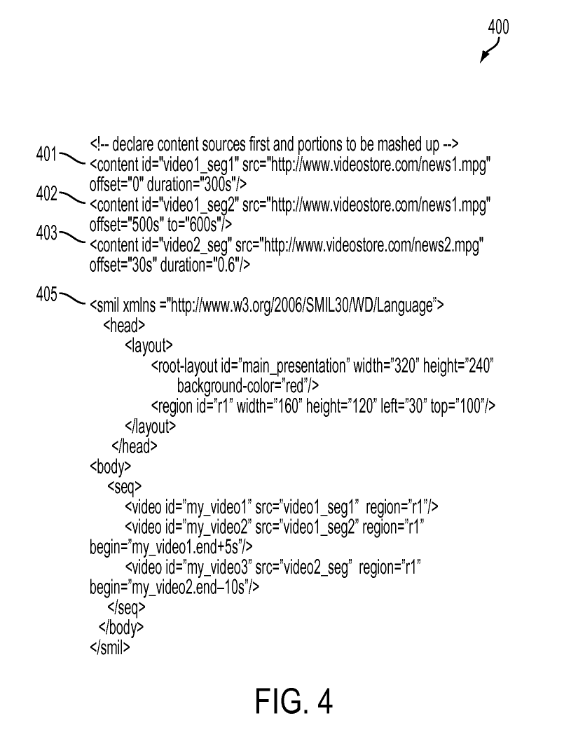

FIG. 4 illustrates a software script including an M3L fragment according to an exemplary embodiment of the present invention.

Referring to FIG. 4, the M3L fragment of the software script 400 includes a first <content> element 401, a second <content> element 402, and a third <content> element 403. Each of the three <content> elements is used to declare multimedia content and specify fragments from two content sources for mashup.

In the example of FIG. 4, the first <content> element 401 includes an “id” attribute to designate a first video fragment or segment (i.e., “video1_seg1”), an “src” attribute to designate a specific link from which the video fragment will be taken (i.e., http://www.videostore.com/news1.mpg), an “offset” attribute to establish an offset from a starting time of the video (i.e., offset=“0”), and a “duration” attribute to designate the length of the extracted video fragment (i.e., duration=“300s”). Thus, the first video fragment is identified as “video1_seg1” and consists of the first 300 seconds of the “news1.mpg” file.

Similar to the first <content> element 401, the second <content> element 402 includes an “id” attribute to designate a second video fragment (i.e., “video1_seg2”), an “src” attribute to designate a specific link from which the second video fragment will be taken (i.e., http://www.videostore.com/news1.mpg), and an “offset” attribute to establish an offset from a starting time of the video at which the fragment will begin (i.e., offset=“500s”). However, the second <content> element 402 includes a “to” attribute to designate a stopping time of the second video fragment (i.e., to =“600s”) rather than a “duration” attribute. In this case, the second video fragment is identified as “video1_seg2” and consists of the 500^{th} to 600^{th} seconds of the “news1.mpg” file.

Similar again to the first <content> element 401, the third <content> element 403 includes an “id”, an “src”, an “offset”, and a “duration” attribute. However, the “duration” attribute of the third <content> element 403 designates a duration of the third video segment in terms of percentage, rather than time. That is, the third <content> element 403 designates that the third video fragment, identified as “video2_seg”, will begin from the 30^{th} second of the news2.mpg file and have a duration equal to 60% of the news2.mpg file.

Of course, it is to be understood that the elements illustrated in FIG. 4 are merely exemplary and not by way of limitation. That is, it should be understood that the example of FIG. 4 provides only a sampling of the M3L elements and attributes defined in Table 2 and that any or all of the remaining elements and attributes may be used to establish a mashup of multimedia content.

The remaining code 405 of the illustrated software script 400 includes Synchronized Multimedia Integration Language (SMIL) elements and attributes that are used for playback of the video fragments designated by the first through third <content> elements 401˜403. SMIL is standardized by the World Wide Web Consortium (W3C) and allows precise synchronization and timing control among multimedia elements. As illustrated in FIG. 4, the second video fragment is played back 5 seconds after the end of the first video fragment and the third video fragment starts playing 10 seconds before the end of the second fragment.

Although not illustrated in FIGS. 2-4, exemplary embodiments of the present invention may further include the simultaneous mashup of content other than multimedia content, such as data, in addition to the mashup of multimedia content. For example, data content may be mashed up to output a resultant transformation of the combined data content while multimedia content is concurrently mashed up to allow precise synchronization and output of the combined multimedia content.

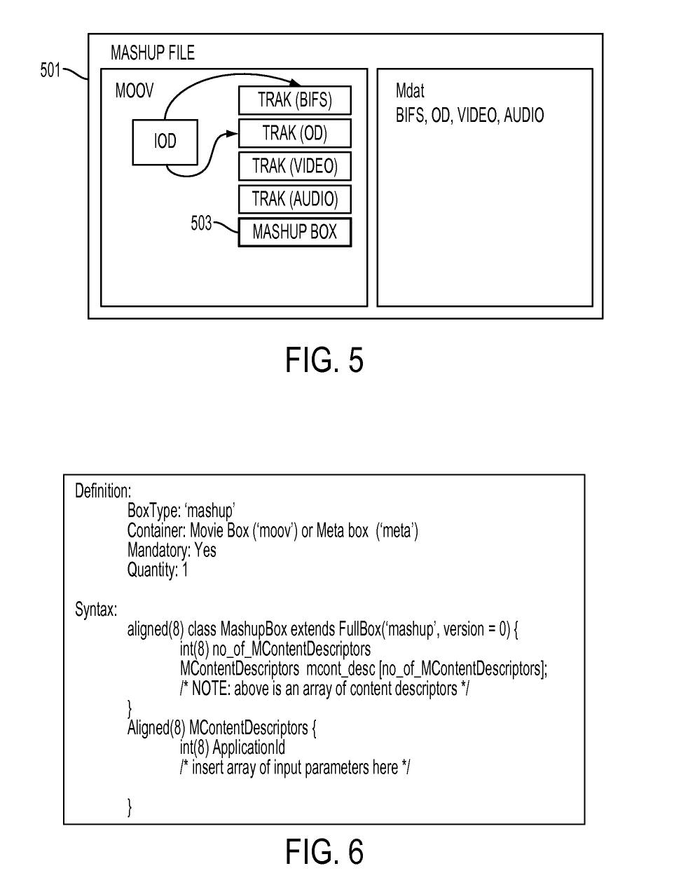

FIG. 5 is a diagram illustrating a file format for storing multimedia mashup content according to an exemplary embodiment of the present invention. FIG. 6 illustrates a syntax for use in a mashup file format according to an exemplary embodiment of the present invention.

Referring to FIG. 5, the Moving Picture Experts Group (MPEG)-4 Part 14 File Format (MP4 FF) 501 is provided as the basis of the multimedia mashup file format but additionally includes a mashup box 503 according to an exemplary embodiment of the present invention. The MP4 FF 501 is in turn derived from the International Organization for Standardization Base Media File Format (ISOBMFF) and hence the mashup box can also be provided as a new box within the ISOBMFF. The mashup box 503 is provided to facilitate storage and delivery of multimedia mashup content. That is, the mashup box 503 is provided in the ISOBMFF for efficiently describing and storing multimedia mashup content. This new file format is capable of storing multimedia content, descriptions of multimedia content, interactivity among the multimedia elements as well as support for referencing of data from multiple sources to be combined or mashed up.

Referring to FIG. 6, a syntax of an initial mashup FF is provided. The syntax includes a list of content descriptors that are defined for the new mashup box. Each content descriptor contains an application ID and a list of other parameters. According to an exemplary implementation, the present invention enables mashup of multiple services/applications as well as reference to both external sources and locally created content, thus the application ID can refer to a service/application, location of external content sources, or location of content stored within the file.

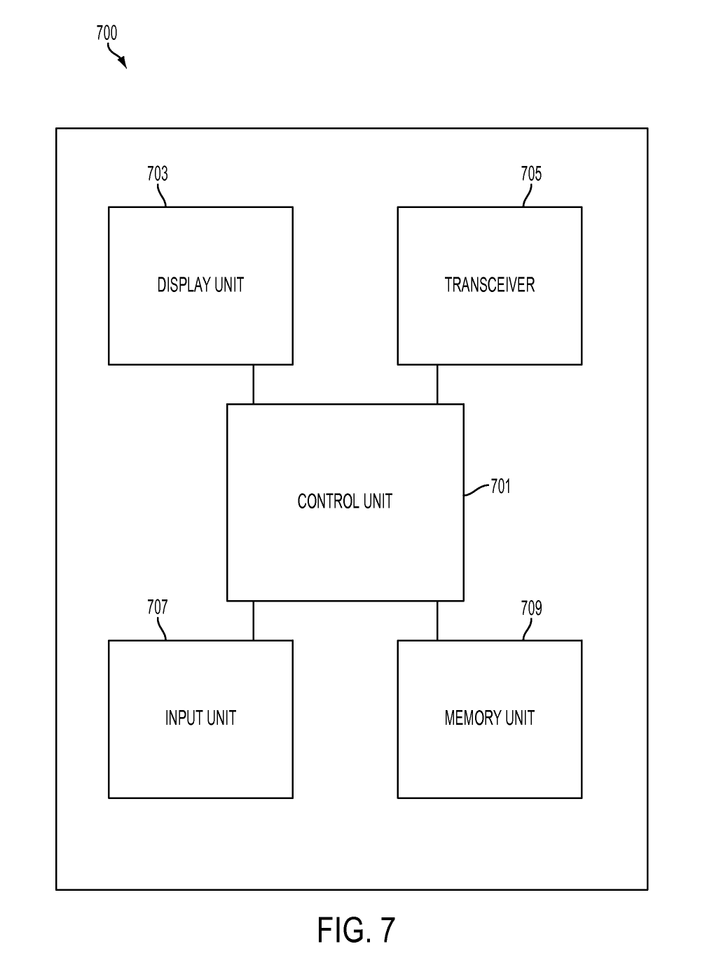

FIG. 7 is a block diagram of an apparatus for executing an M3L script according to an exemplary embodiment of the present invention.

Referring to FIG. 7, the apparatus 700 includes a control unit 701, a display unit 703, a transceiver 705, an input unit 707, and a memory unit 709. According to exemplary implementations of the present invention, the apparatus 700 may be a component within a portable device such as a mobile terminal, a Personal Digital Assistant (PDA), a User Equipment (UE), a laptop computer, and the like, and may be a component within a stationary device such as a desktop computer, a television set, a set top box, and the like.

The control unit 701 is provided to receive user input through the input unit 707, to receive multimedia content from distinct sources through the transceiver 705 in response to user input, to store and retrieve necessary information from the memory unit 709, and to output information to the display unit 703. More specifically, the control unit 701 is provided to receive user input through the input unit 707. According to an exemplary implementation, the user input may be a request to execute a program that includes the mashup of multimedia information. For example, as described above with reference to FIG. 3, the user input may be a request to select and display a certain news topic from two distinct sources of news.

The input unit 707 may include a key pad, a mouse ball, or other input means by which a user is able to select and control desired operations of the apparatus 700. The display unit 703 is provided for displaying a signal output by the control unit 701. For example, the display unit 703 may output a result of a mashup of multimedia content, such as the selected news topic as illustrated in FIG. 3. In an exemplary implementation, the display unit 703 may be provided as a Liquid Crystal Display (LCD). In this case, the display unit 703 may include a controller for controlling the LCD, a video memory in which image data is stored and an LCD element. If the LCD is provided as a touch screen, the display unit 703 may perform a part or all of the functions of the input unit 707.

The transceiver 705 is controlled by the control unit 701 to transmit a request for and to receive desired information, such as multimedia content. That is, the transceiver 705 communicates with external devices such as an Internet provider, and may include a wired and/or wireless connection. The transceiver 705 may, for example, include a Radio Frequency (RF) transmitter and receiver for wireless communication. The transceiver 705 may also support communication via a variety of protocols, including Bluetooth, Wi-Fi, cellular service (e.g., 3^{rd} Generation and 4^{th} Generation services), Ethernet, Universal Serial Bus (USB), and the like. The memory unit 709 may include both a volatile and a non-volatile memory for storing various types of information. For example, the memory unit 709 may include a volatile memory for storing temporary data that is generated during the execution of various functions of the control unit 701. Additionally, the memory unit 709 may include a non-volatile memory for storing data such as a program for executing an M3L file, multimedia content that is received and configured by the control unit 701, multimedia data that is the result of a mashup of received multimedia data, and the like.

Certain aspects of the present invention can also be embodied as computer readable code on a computer readable recording medium. A computer readable recording medium is any data storage device that can store data which can be thereafter read by a computer system. Examples of the computer readable recording medium include Read-Only Memory (ROM), Random-Access Memory (RAM), Compact Disc (CD)-ROMs, magnetic tapes, floppy disks, and optical data storage devices. The computer readable recording medium can also be distributed over network coupled computer systems so that the computer readable code is stored and executed in a distributed fashion. Also, functional programs, code, and code segments for accomplishing the present invention can be easily construed by programmers skilled in the art to which the present invention pertains.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for combining multimedia data, the method comprising:
obtaining first multimedia content from a first source;
obtaining second multimedia content from a second source;
selectively combining the first multimedia content with the second multimedia content; and
outputting the selectively combined multimedia content.

2. The method of claim 1, wherein the selectively combining of the first multimedia content with the second multimedia content comprises combining the first multimedia content and the second multimedia content according to a spatial selection.

3. The method of claim 1, wherein the selectively combining of the first multimedia content with the second multimedia content comprises combining the first multimedia content and the second multimedia content according to a temporal selection.

4. The method of claim 1, further comprising:
determining a transport mechanism for outputting the combined content,
wherein the selectively combining of the first multimedia content with the second multimedia content comprises combining the first multimedia content and the second multimedia content according to the determined transport mechanism, and
wherein the outputting of the selectively combined multimedia content comprises outputting the combined content according to the determined transport mechanism.

5. The method of claim 4, wherein the determining of the transport mechanism comprises determining use of at least one of a broadcast mechanism, a broadband mechanism, and a streaming mechanism.

6. The method of claim 1, further comprising:
determining a characteristic of a device on which the output content is to be displayed,
wherein the selectively combining of the first multimedia content with the second multimedia content comprises combining the first multimedia content and the second multimedia content according to the determined characteristic, and
wherein the outputting of the selectively combined multimedia content comprises outputting the combined content according to the determined characteristic.

7. The method of claim 6, wherein the determining of the characteristic of the device comprises determining at least one of a screen size, a screen resolution, and an available memory size.

8. The method of claim 1, wherein the selectively combining of the first multimedia content with the second multimedia content comprises combining less than the entirety of the first multimedia content with less than the entirety of the second multimedia content.

9. The method of claim 1, further comprising:
obtaining third content;
obtaining fourth content; and
selectively combining and outputting the third content and the fourth content,
wherein the selectively combining of the first multimedia content with the second multimedia content comprises combining the first multimedia content and the second multimedia content according to at least one of a temporal selection and a spatial selection for precise synchronization.

10. An apparatus for combining multimedia data, the apparatus comprising:
a transceiver unit for obtaining first multimedia content from a first source and for obtaining second multimedia content from a second source; and
a control unit for selectively combining the first multimedia content with the second multimedia content and for controlling output the selectively combined multimedia content by the transceiver.

11. The apparatus of claim 10, wherein the wherein the control unit selectively combines the first multimedia content with the second multimedia content according to a spatial selection.

12. The apparatus of claim 10, wherein the control unit selectively combines the first multimedia content with the second multimedia content by combining the first multimedia content and the second multimedia content according to a temporal selection.

13. The apparatus of claim 10, wherein the control unit determines a transport mechanism for outputting the combined content,
wherein the control unit selectively combines the first multimedia content with the second multimedia content by combining the first multimedia content and the second multimedia content according to the determined transport mechanism, and
wherein the control unit controls the output of the selectively combined multimedia content by outputting the combined content according to the determined transport mechanism.

14. The apparatus of claim 13, wherein the control unit determines the transport mechanism by determining use of at least one of a broadcast mechanism, a broadband mechanism, and a streaming mechanism.

15. The apparatus of claim 10, wherein the control unit determines a characteristic of a device on which the output content is to be displayed,
wherein the control unit selectively combines the first multimedia content with the second multimedia content by combining the first multimedia content and the second multimedia content according to the determined characteristic, and
wherein the control unit controls the output of the selectively combined multimedia content by outputting the combined content according to the determined characteristic.

16. The apparatus of claim 15, wherein the control unit determines the characteristic of the device by determining at least one of a screen size, a screen resolution, and an available memory size.

17. The apparatus of claim 10, wherein the control unit selectively combines the first multimedia content with the second multimedia content by combining less than the entirety of the first multimedia content with less than the entirety of the second multimedia content.

18. The apparatus of claim 10, wherein the transceiver obtains third content, obtains fourth content, and selectively combines and outputs the third content and the fourth content, and wherein the control unit selectively combines the first multimedia content with the second multimedia content by combining the first multimedia content and the second multimedia content according to at least one of a temporal selection and a spatial selection for precise synchronization.

19. A non-transitory computer readable medium for implementing the method of claim 1.
